(19) United States
(12) Patent Application Publication
(10) Pub. No.: US 2008/0164744 A1
(43) Pub. Date: Jul. 10, 2008

(54) Plastic stool and a method for making the same

(76) Inventor: Tse-Hui Wang, Taichung County (TW)

Correspondence Address: Tse-Hui Wang, P.O.Box 44-2049, Taipei, 10668, omitted

(21) Appl. No.: 11/649,772

(22) Filed: Jan. 5, 2007

(51) Int. Cl. A47C 7/16; B29C 45/16

(52) U.S. Cl. 297/452.18; 264/250; 264/247

(57) ABSTRACT

A method for making a plastic stool includes a step of first injection which ejects a first thermoplastic material in a first mold to form a base form which has an open top, a step of second injection which puts the base form in a second mold and uses a second thermoplastic material to be injected in the second mold, the second thermoplastic material is formed as a seat portion which is engaged with the open top of the base form. The second first thermoplastic material is softer than the first thermoplastic material and has a plurality of ventilation holes.

### BACKGROUND OF THE INVENTION

(1) Field of the Invention

The present invention relates to a method for making a stool by way of plastic injection molding and the stool includes two parts of different stiffness.

(2) Description of the Prior Art

A conventional stool made by way of plastic injection molding generally includes a seat portion and four legs which are integrally formed with the seat portion which is a flat or curved surface. The material for the stool generally is hard so as to provide sufficient support and the hard material is durable so that the stools can be stacked and do not need too much maintenance. However, the hard material is too hard and the seat portion does not ventilate so that the conventional plastic stool does not make user feel comfortable.

The present invention intends to provide a plastic stool and a method for making the same, wherein the method includes two plastic injection molding steps for making the frame and the seat portion respectively. The material for the seat portion is softer than that for the frame so that the plastic stool improves the shortcoming of the conventional plastic stool.

### SUMMARY OF THE INVENTION

The present invention relates to a method for making a plastic stool, wherein the method comprises a step of first injection: using a first thermoplastic material to be injected in a first mold to form a base form which has an open top; a step of second injection: putting the base form in a second mold and using a second thermoplastic material to be injected in the second mold, the second thermoplastic material being formed as a seat portion which is engaged with the open top of the base form, and a step of removing the stool from the second mold.

The primary object of the present invention is to provide a method for making a plastic stool which is made by two different thermoplastic materials and the seat portion of the stool is softer than the base form of the stool so as to have a comfortable and strong stool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the base form of the plastic stool of the present invention;

FIG. 2 is a perspective view to show the plastic stool of the present invention;

FIG. 3 is a side cross sectional view to show the plastic stool of the present invention;

FIG. 4 shows another embodiment of the base form of the plastic stool of the present invention;

FIG. 4A shows a cross sectional view of the connection portion of the base form in FIG. 4;

FIG. 5 is a perspective view of the plastic stool in FIG. 4 of the present invention;

FIG. 6 is a side cross sectional view of the plastic stool in FIG. 4 of the present invention;

FIG. 7 shows a seat portion of the present invention;

FIG. 8 shows an office chair employing the seat portion of the present invention, and

FIG. 9 shows a flow chart of the steps of the method for making the plastic stool of the present invention.

### DETAILED DESCRIPTION OF THE PREFERRED EMBODIMENTS

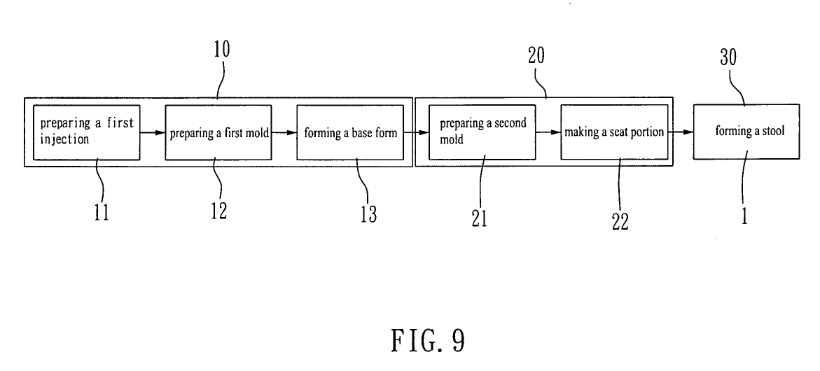

Referring to FIG. 9 which shows a flow chart of the steps of the method for making the plastic stool of the present invention, wherein the method comprises a first injection 10, a second injection 20 and a step of forming a stool 30. The first injection 10 includes a step of preparing a first thermoplastic material 11 which is injected in a first mold 12 to form a base form 13 which has an open top. The second injection 20 includes a step of preparing a second mold 21 and a step of making a seat portion 22. The step of forming a stool 1 is to connect the seat portion 22 with the open top of the base form 13. It is noted that the sequence of the first injection 10 and the second injection 20 can be changed. The seat portion can be made first and then the base form is made.

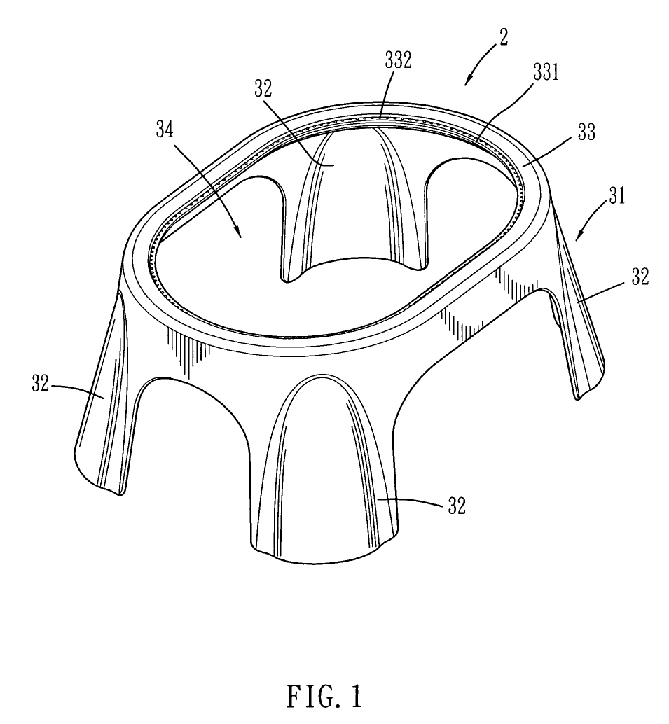

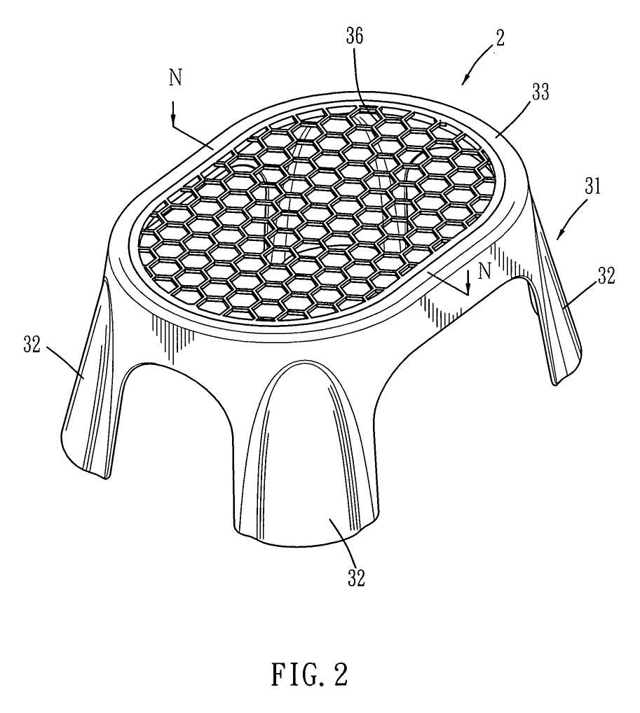

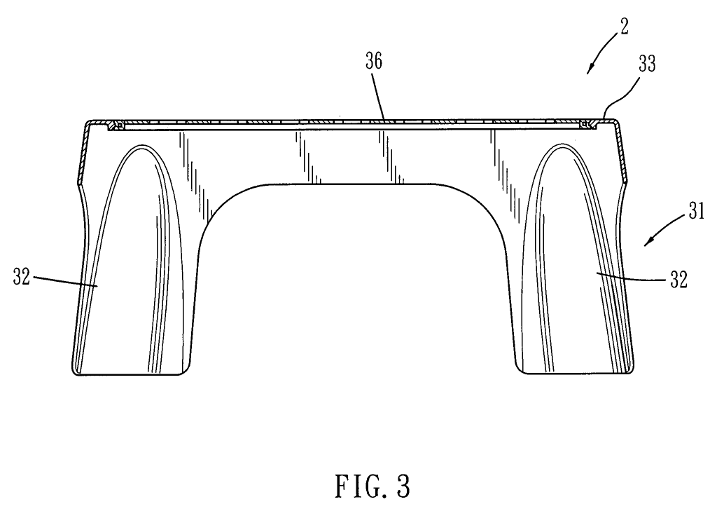

Referring to FIGS. 1 to 3, the preferable embodiment of the plastic tool 2 is shown wherein the base form 31 includes a connection ring 33 which encloses the open top 34 and four legs 32 are connected with the connection ring 33. A connection portion 331 extends inward from an inner periphery of the connection ring 33 and located lower than a top surface of the connection ring 33. A plurality of connection holes 332 are defined through the connection portion 331. The seat portion 36 is engaged with the connection ring 33 with the second thermoplastic material engaged with the connection holes 332. The seat portion 36 includes a plurality of ventilation holes and the second thermoplastic material is softer than that of the first thermoplastic material. The base form 31 and the seat portion 36 can be made by different colors.

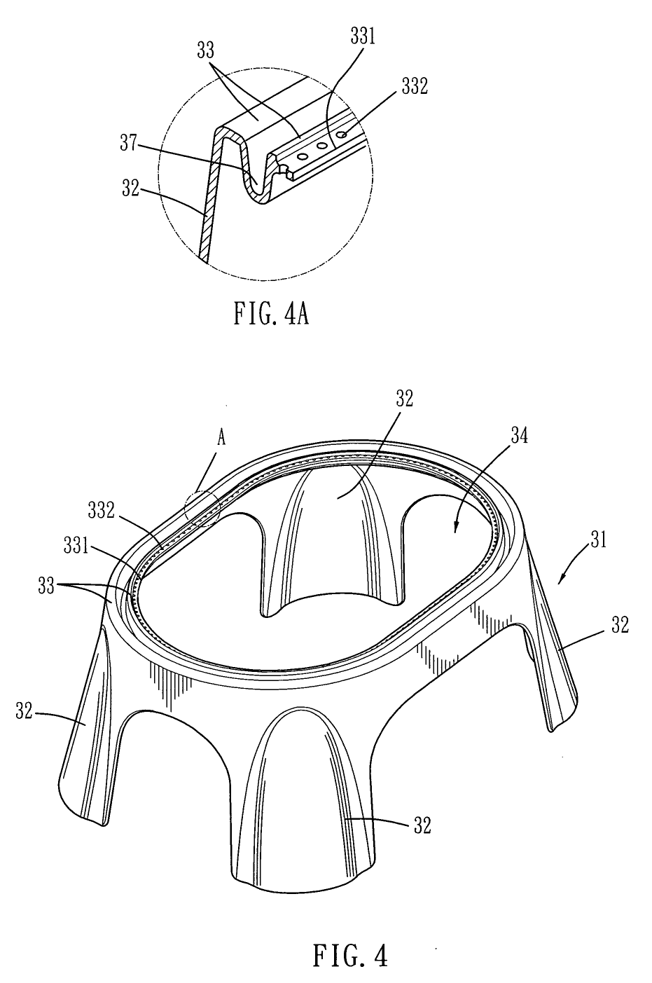

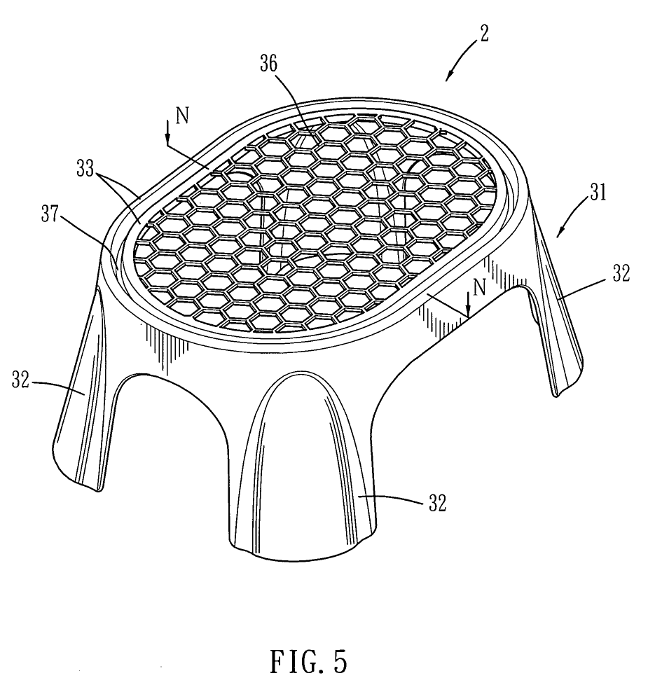

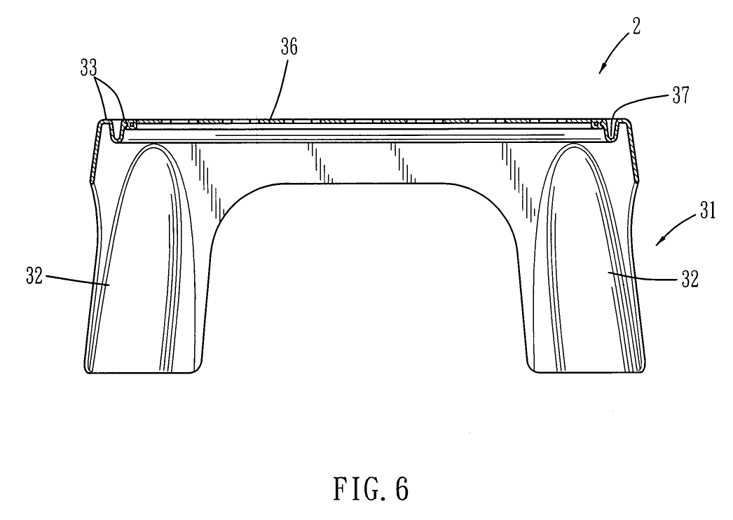

FIGS. 4, 4A, 5 and 6 show another preferable embodiment of the plastic stool 2 wherein the base form 31 includes a connection ring 33 which encloses the open top 34 and four legs 32 are connected with the connection ring 33. A groove 37 is defined in the connection ring 33 so as to make the connection ring 33 have a substantially U-shaped cross section as shown in FIG. 4A. A connection portion 331 extends inward from an inner periphery of the connection ring 33 and a plurality of connection holes 332 are defined through the connection portion 331. The seat portion 36 is engaged with the connection ring 33 with the second thermoplastic material engaged with the connection holes 332. The seat portion 36 includes a plurality of ventilation holes and the second thermoplastic material is softer than that of the first thermoplastic material. The substantially U-shaped connection ring 33 provides a cushion function to the users.

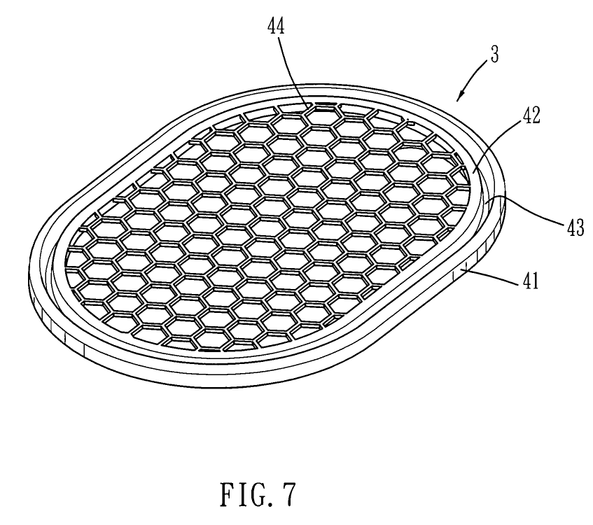

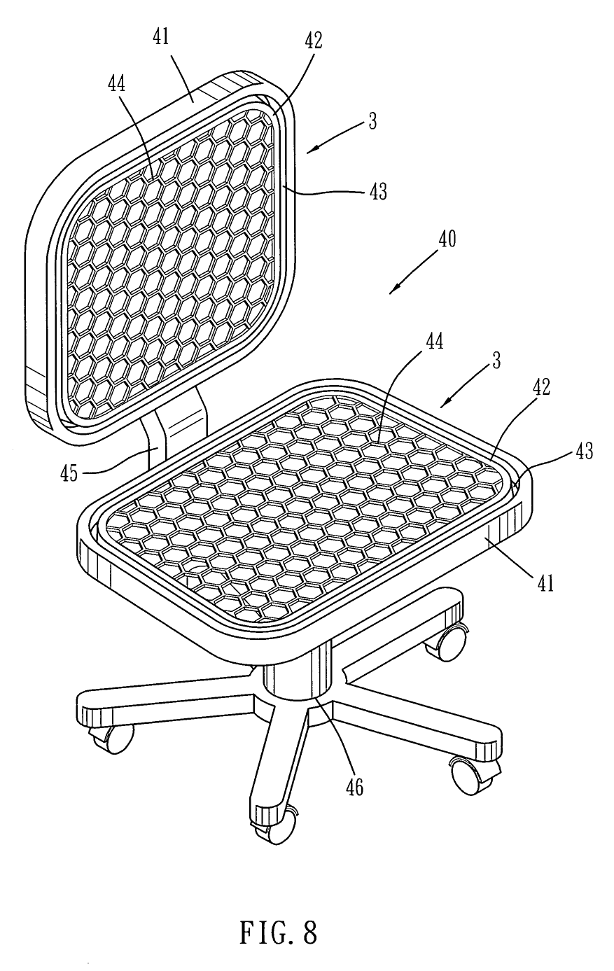

FIG. 7 shows a seat portion 3 which has a connection ring 41 with the substantially U-shaped groove 43 defined therein so as to form a connection portion 42 which is connected with a netted seat surface 44. FIG. 8 shows that two seat portions 3 are combined with each other to form an office chair, wherein one of the seat portions 3 is used as a back and the other seat portion 3 is used as the seat portion. A connection frame 45 is connected between the back and the seat portion, and a leg unit 46 with clusters is connected to the underside of the seat portion.

While we have shown and described the embodiment in accordance with the present invention, it should be clear to those skilled in the art that further embodiments may be made without departing from the scope of the present invention.

What is claimed is:

1. A method for making a plastic stool, comprising:
a step of first injection: using a first thermoplastic material to be injected in a first mold to form a base form which has an open top;
a step of second injection: putting the base form in a second mold and using a second thermoplastic material to be injected in the second mold and the second thermoplastic material being formed as a seat portion which is engaged with the open top of the base form, and
a step of removing the stool from the second mold.

2. The method as claimed in claim 1, wherein the base form includes a connection ring and four legs connected with the connection ring.

3. The method as claimed in claim 1, wherein the seat portion is engaged with the connection ring.

4. The method as claimed in claim 1, wherein the seat portion includes a plurality of ventilation holes.

5. The method as claimed in claim 1, wherein the base form and the seat portion are different colors.

6. A method for making a plastic stool, comprising:
a step of first injection: using a first thermoplastic material to be injected in a first mold and the first thermoplastic material being formed as a seat portion which has a plurality of connection holes along a periphery thereof;
a step of second injection: putting the seat portion in a second mold and using a second thermoplastic material to be injected in a second mold to form a base form, the second thermoplastic material engaged with the connection holes of the seat portion so as to form a stool, and
a step of removing the stool from the second mold.

7. A plastic stool comprising:
a base form made by a first thermoplastic material and having an open top, a connection portion connected to an inner periphery of the open top, a plurality of connection holes defined through the connection portion, and
a seat portion made by a second thermoplastic material and being connected to the connection portion.

8. The plastic stool as claimed in claim 7, wherein the base form includes four legs.

9. The plastic stool as claimed in claim 7, wherein the open top of the base form is defined by a connection ring.

10. The plastic stool as claimed in claim 9, wherein a back is connected to the base form and a leg unit with clusters is connected to the seat portion.
